(19) United States
(12) Patent Application Publication
(10) Pub. No.: US 2016/0053877 A1
(43) Pub. Date: Feb. 25, 2016

(54) TRANSMISSION FOR ELECTRIC VEHICLE

(71) Applicant: Hyundai Motor Company, Seoul (KR)

(72) Inventor: Jong Yun PARK, Hwaseong-si (KR)

(73) Assignee: Hyundai Motor Company, Seoul (KR)

(21) Appl. No.: 14/559,141

(22) Filed: Dec. 3, 2014

(30) Foreign Application Priority Data
Aug. 22, 2014 (KR) 10-2014-0109800

(51) Int. Cl. F16H 37/04; F16H 63/30

(52) U.S. Cl. CPC F16H 37/043; F16H 63/30; F16H 2063/3093

(57) ABSTRACT

A transmission apparatus for an electric vehicle may include an input shaft receiving torque from a power source, an output shaft disposed in parallel with the input shaft, a first driving gear disposed on the input shaft, a second driving gear disposed on the input shaft, a first driven gear disposed on the output shaft and generating a first transmission gear ratio by engaging with the first driving gear, a second driven gear disposed on the output shaft to rotate integrally with the output shaft and generating a second transmission gear ratio by engaging with the second driving gear, a first clutch member changing connection of the first driving gear or the second driving gear to the input shaft, a second clutch member changing connection of the first driving gear to the input shaft, and a third clutch member changing connection of the second driving gear to the input shaft.

### CROSS REFERENCE TO RELATED APPLICATION

The present application claims priority of Korean Patent Application Number 10-2014-0109800 filed on Aug. 22, 2014, the entire contents of which application are incorporated herein for all purposes by this reference.

### BACKGROUND OF THE INVENTION

1. Field of the Invention

The present invention, in general, relates to a transmission for an electric vehicle, and, more particularly, to the structure of a transmission that can improve driving performance of a vehicle by properly transmitting power from an electric motor to driving wheels in an electric vehicle that is driven by the electric motor.

2. Description of Related Art

Electric vehicles are driven by torque generated by an electric motor, which is activated by electricity, and transmitted to driving wheels.

Power systems that operate driving wheels with power generated by an electric motor and then simply reduced through a reduction gear were generally used in the related art, but recently, there has been an effort to improve the driving range and the driving performance of vehicles by more effectively transmitting power from an electric motor to driving wheels.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a transmission for an electric vehicle which can improve the driving performance of an electric vehicle by providing two transmission gear ratios and which can increase the fuel efficiency and the driving range of an electric vehicle by minimizing power consumption.

In an aspect of the present invention, there is provided a transmission for an electric vehicle which may include an input shaft receiving torque from a power source, an output shaft disposed in parallel with the input shaft, a first driving gear disposed on the input shaft to freely rotate, a second driving gear disposed on the input shaft to freely rotate, a first driven gear disposed on the output shaft to rotate integrally with the output shaft and generating a first transmission gear ratio by engaging with the first driving gear, a second driven gear disposed on the output shaft to rotate integrally with the output shaft and generating a second transmission gear ratio by engaging with the second driving gear, a first clutch member changing connection of the first driving gear or the second driving gear to the input shaft, a second clutch member changing connection of the first driving gear to the input shaft, and a third clutch member changing connection of the second driving gear to the input shaft.

Accordingly the present invention, it is possible to improve the driving performance of an electric vehicle by providing two of transmission gear ratios and to increase the fuel efficiency and the driving range of an electric vehicle by minimizing power consumption.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing the configuration of a transmission for an electric vehicle according to an exemplary embodiment of the present invention.

FIG. 2 is a diagram showing the transmission of FIG. 1 operating with a first gear engaged.

FIG. 3, FIG. 4, FIG. 5, FIG. 6 and FIG. 7 are diagrams sequentially showing the process of shifting from the state of FIG. 2 to a second gear.

FIG. 8 is a diagram showing the transmission of FIG. 1 operating with the second gear engaged.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

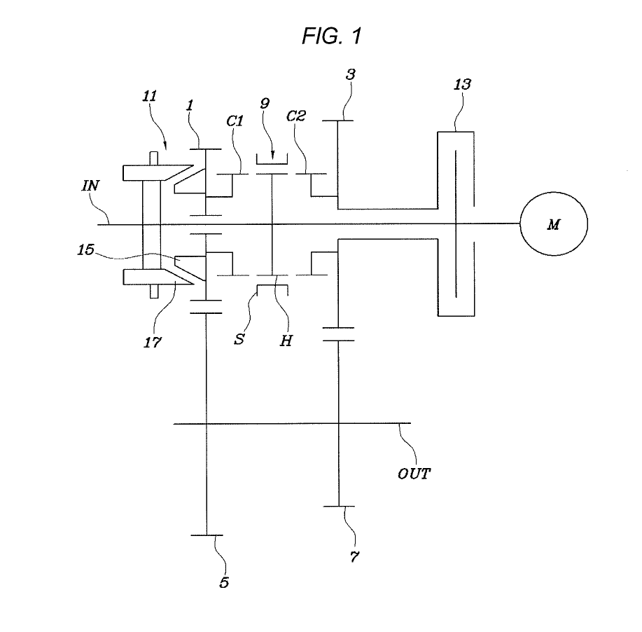

Referring to FIG. 1, an exemplary embodiment of a transmission for an electric vehicle of the present invention includes: an input shaft IN that receives torque from a power source, an output shaft OUT that is disposed in parallel with the input shaft IN, a first driving gear 1 that is disposed on the input shaft IN to be capable of rotating freely, a second driving gear 3 that is disposed on the input shaft IN to be capable of rotating freely, a first driven gear 5 that is disposed on the output shaft OUT to rotate integrally with it and generates a first transmission gear ratio by engaging with the first driving gear 1, a second driven gear 7 that is disposed on the output shaft OUT to rotate integrally with it and generates a second transmission gear ratio by engaging with the second driving gear 3, a first clutch member 9 that can change connection of the first driving gear 1 or the second driving gear 3 to the input shaft IN, a second clutch member 11 that can change connection of the first driving gear 1 to the input shaft IN, and a third clutch member 13 that can change connection of the second driving gear 3 to the input shaft IN.

That is, according to the exemplary embodiment of the present invention, the input shaft IN is connected to an electric motor M that is the power source, such that as the input shaft IN receives power from the electric motor M and rotates the first driving gear 1 or the second driving gear 3, the first driven gear 5 or the second driven gear 7 on the output shaft OUT operates and output at the first transmission gear ratio or the second transmission gear ratio comes out from the output shaft OUT. Further, there are provided the second clutch member 11 that can connect the first driving gear 1 to the input shaft IN and the third clutch member 13 that can connect the second driving gear 3 to the input shaft IN.

In the present embodiment, the first clutch member 9 is a dog clutch that does not consume power with the first driving gear 1 or the second driving gear 3 connected to the input shaft IN.

That is, when the sleeve S moves from a neutral position to the first driving gear 1 and engages with a clutch gear C1 of the first driving gear 1, the dog clutch can keep the first driving gear 1 connected to the input shaft IN through a hub without additional power. Further, when the sleeve S engages with a clutch gear C2 of the second driving gear 3, it can keep the second driving gear 3 connected to the input shaft IN through a hub without additional power.

Obviously, a synchro member that can perform synchronization in addition to the function of the dog clutch may be used for the first clutch member 9.

In the present embodiment, the second clutch member 11 is a conical clutch of which the contact surface for transmitting power is formed in a conical shape.

The conical clutch includes a male cone 15 laterally protruding from the first driving gear 1 and having a conical outer surface and a female cone 17 disposed at and slide long the input shaft IN and having a conical inner surface to come in contact with the outer surface of the male cone 15.

Using a conical clutch for the second clutch member 11 is for sufficient transmission of power with a relatively small volume and large clutch capacity by making the conical clutch supply torque instead to the output shaft, even if the sleeve S of the dog clutch disengages from the clutch gear C1 of the first driving gear 1 for shifting from the first gear to the second gear and the first driving gear 1 cannot transmit power to the output shaft OUT through the first driven gear 5.

On the other hand, the third clutch member 13 is a dry-disc friction clutch and it can be manufactured with a simple configuration and small weight, as compared with a wet type clutch, resulting in contributing to improving the driving range and the fuel efficiency of an electric vehicle.

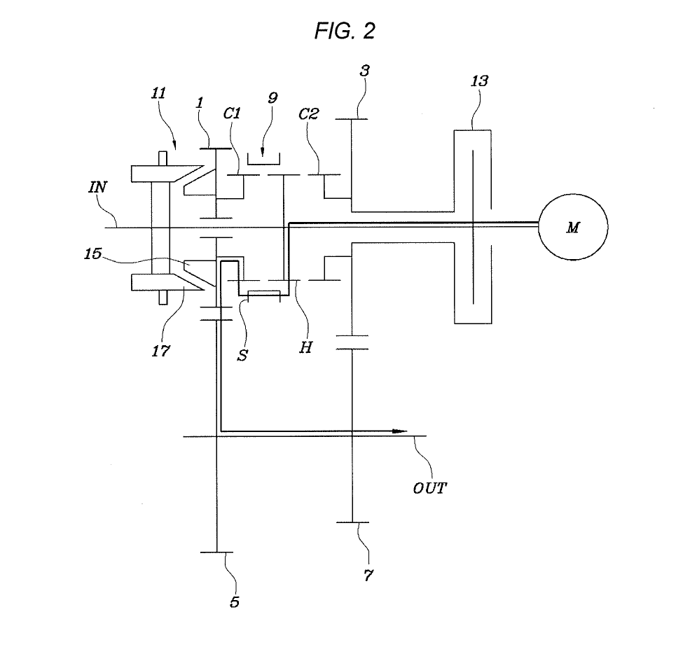

The operation of the transmission for an electric vehicle which has the configuration described above is described with reference to FIGS. 2 to 8.

FIG. 2 shows a case when an electric vehicle is driven with a first gear engaged, in which, with the vehicle stopped, the sleeve S of the dog clutch is moved to the left from the neutral position and engages with the clutch gear C1 of the first driving gear 1 and then the electric motor M is activated, thereby performing first-gear shifting.

That is, the power from the electric motor M is transmitted to the first driving gear 1 sequentially through the hub H on the input shaft IN and the sleeve S and then the power is transmitted to the first driven gear 5, such that shifting is achieved and first gear output comes out through the output shaft OUT.

For reference, a reverse gear is engaged by reversing the electric motor M in this state.

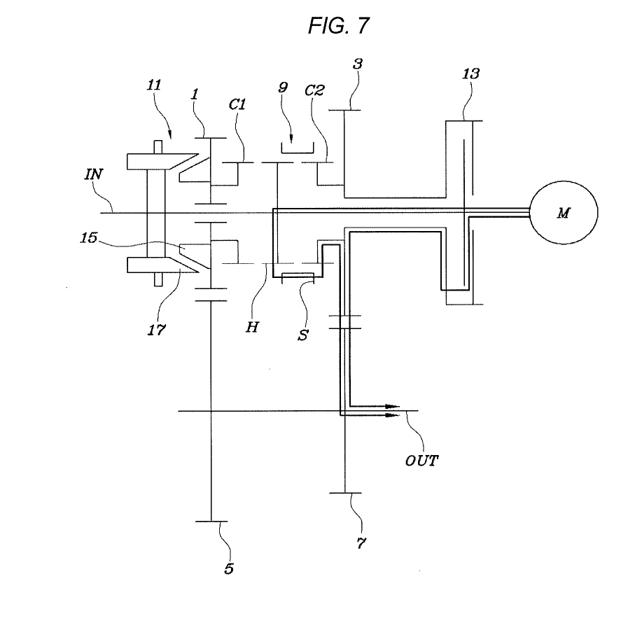

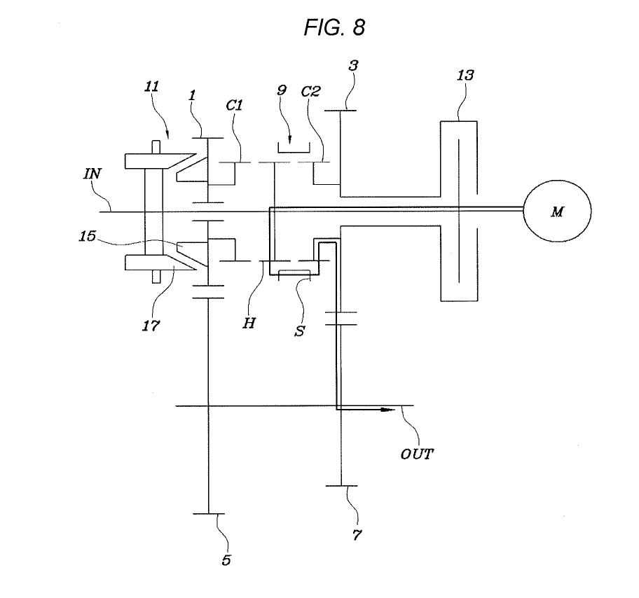

FIG. 8 shows a case when a vehicle is driven with the second gear engaged, in which the clutch gear C2 of the second driving gear 3 is connected to the hub H by the sleeve S of the dog clutch and second-gear shifting is achieved by the power generated from the electric motor M and transmitted through the second driving gear 3 and the second driven gear 7, such that second gear output comes out through the output shaft OUT.

The process of shifting from the state of FIG. 2 to the state of FIG. 8 is sequentially shown in FIGS. 2 to 7 and it is described hereafter.

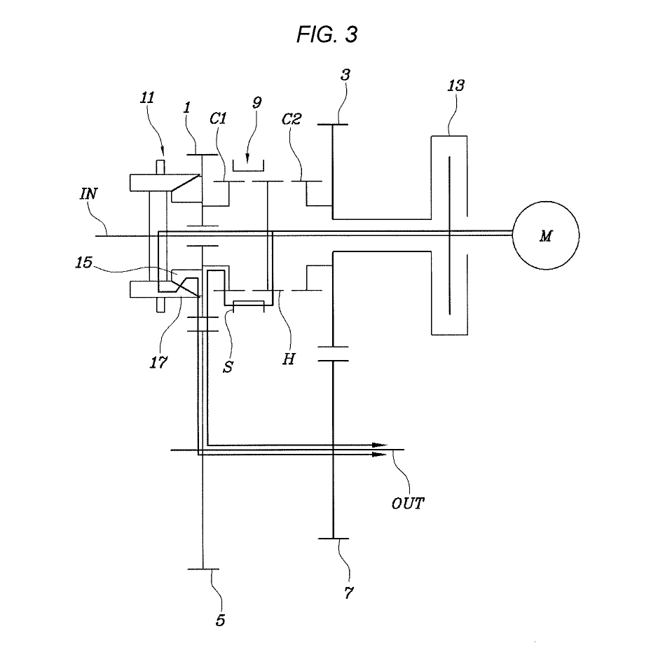

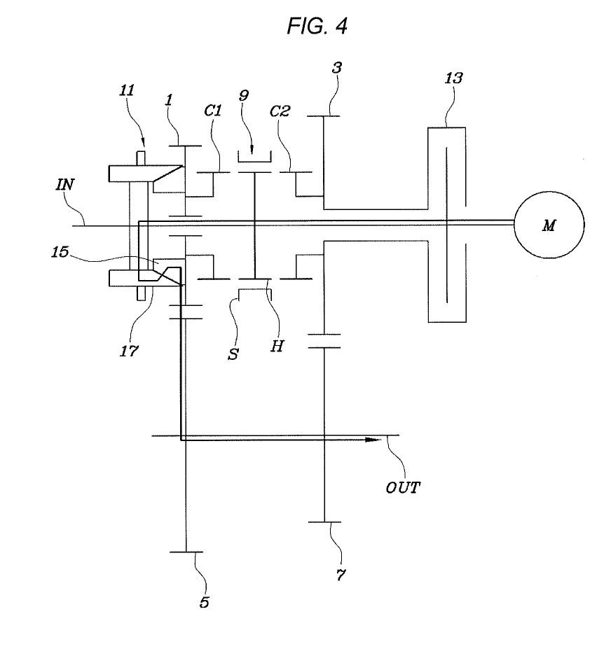

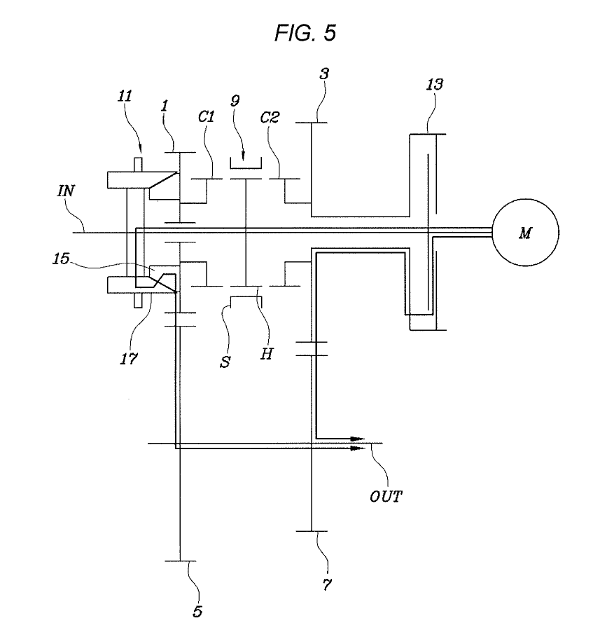

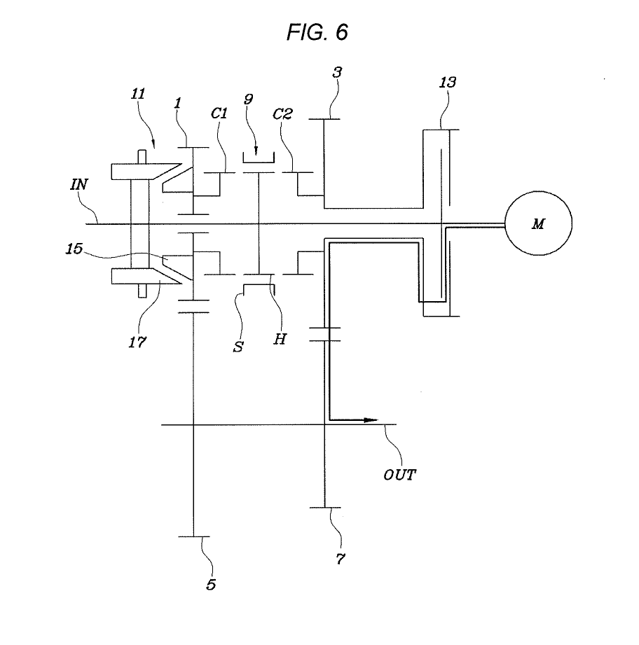

When the state of FIG. 3 is made by engaging the conical clutch that is the second clutch member 11 from the state of FIG. 2, the conical clutch, the input shaft IN, and the first driving gear 1 integrally rotate so that first transmission gear ratio is obtained at the first driven gear 5, and it is outputted through the output shaft OUT.

In FIG. 4, the dog clutch is disengaged in FIG. 4, but the conical clutch remains engaged, so the power from the input shaft IN is continuously transmitted to the first driving gear 1, and thus, power is continuously supplied to the output shaft OUT.

The dry-disc friction clutch that is the third clutch member 13 starts to engage for shifting to the second gear in FIG. 5 and the conical clutch is disengaged in FIG. 6, such that the power from the electric motor M is now transmitted to the second driving gear 3 through the third clutch member 13 and then outputted from the output shaft OUT through the second driven gear 7, thereby actually achieving shifting to the second gear.

In the processes of FIGS. 5 and 6, the third clutch member 13 is engaged and the second clutch member 11 is disengaged to avoid their interference with each other and to maintain the supply of power to the output shaft OUT, thereby improving the shifting operation of the vehicle.

The sleeve S of the dog clutch engages with the clutch gear C2 of the second driving gear 3 in FIG. 7 and the third clutch member 13 is disengaged in FIG. 8, such that the second-gear shifting is stably maintained by the dog clutch while power for keeping the third clutch member 13 engaged is not consumed any more.

According to the transmission for an electric vehicle of the present invention, as described above, power is temporarily consumed to operate the second clutch member 11 and the third clutch member 13 only in shifting, and after shifting, the shifting is stably maintained by the dog clutch without power consumption, such that energy consumption is minimized. Therefore, it is possible to improve the driving range and the fuel efficiency of a vehicle.

Further, as described above, since the power from the electric motor M can be supplied to driving wheels through two steps of shifting, it is possible to improve the operation efficiency of the electric motor M and the accelerating and uphill-driving abilities of an electric vehicle, as compared with the related art of providing power from the electric motor M to driving wheels simply through a reduction gear.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A transmission apparatus for an electric vehicle, comprising:
an input shaft receiving torque from a power source;
an output shaft disposed in parallel with the input shaft;
a first driving gear disposed on the input shaft to freely rotate;
a second driving gear disposed on the input shaft to freely rotate;
a first driven gear disposed on the output shaft to rotate integrally with the output shaft and generating a first transmission gear ratio by engaging with the first driving gear;
a second driven gear disposed on the output shaft to rotate integrally with the output shaft and generating a second transmission gear ratio by engaging with the second driving gear;
a first clutch member changing connection of the first driving gear or the second driving gear to the input shaft;
a second clutch member changing connection of the first driving gear to the input shaft; and
a third clutch member changing connection of the second driving gear to the input shaft.

2. The transmission apparatus of claim 1, wherein the first clutch unit is a dog clutch configured for not consuming power with the first driving gear or the second driving gear connected to the input shaft.

3. The transmission apparatus of claim 2, wherein the second clutch unit is a conical clutch a contact surface for transmitting power of which is formed in a conical shape.

4. The transmission apparatus of claim 3, wherein the conical clutch includes:
a male cone laterally protruding from the first driving gear and having a conical outer surface; and
a female cone configured to be disposed at and slide along the input shaft and having a conical inner surface to come in contact with the conical outer surface of the male cone.

5. The transmission apparatus of claim 2, wherein the third clutch member is a dry-disc friction clutch.
